(19) United States
(12) Patent Application Publication
(10) Pub. No.: US 2004/0076460 A1
(43) Pub. Date: Apr. 22, 2004

(54) Phosphorescent writing system

(75) Inventors: Sun Yu, Berkley, MI (US); David Perrin, Berkley, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Zen Design Group, Ltd., Berkley, MI

(21) Appl. No.: 10/339,541

(22) Filed: Jan. 9, 2003

Related U.S. Application Data
(60) Provisional application No. 60/358,624, filed on Feb. 21, 2002.

(51) Int. Cl. B43M 1/02

(52) U.S. Cl. 401/1

(57) ABSTRACT

A writing surface has a phosphorescent or fluorescent material thereon that has an excitation energy that is less than the photon energy emitting from a penlight stylus light source or emitted through a transparent writing surface. The phosphor security ink is selectively excited only where exposed to light emission from the stylus thereby creating a phosphorescent or fluorescent glow visible under low ambient light conditions. The phosphorescent material is adhered to the writing surface or decorates a ferrite particulate which is drawn onto the writing surface through the influence of a magnet.

### RELATED APPLICATION

This application claims priority of U.S. Provisional Patent Application Serial No. 60/358,624 filed Feb. 21, 2002, and is incorporated herein by reference.

### FIELD OF THE INVENTION

The present invention relates in general to a light-based writing system and, in particular, to a phosphorescent writing system using a light emitting diode penlight to both write and erase.

### BACKGROUND OF THE INVENTION

Reading and writing under low light conditions has been a problem since the beginning of civilization. Efforts to provide sufficient lighting have changed with technology from candlelight, to incandescent, and later to fluorescent lighting systems. In spite of the advances, efforts still focus on illuminating a space around the page. Alternative approaches have involved radioactive radium inks that have proven to be too toxic, and phosphorescent ink or dye usage that has proven to be ineffective absent sufficient light to stimulate phosphors.

Japanese Patent 407314981A disclosed a board containing a molecule that changes color upon irradiation with a first wavelength of light and erasure with a second wavelength. However, this board again does not itself make legible the writings absent ambient light.

Thus, there exists a need for a writing system capable of allowing the writing and communication of the writing to an observer absent ambient light.

### SUMMARY OF THE INVENTION

The writing system includes a penlight stylus having a light source. A battery is selectively connected in a circuit with the light source by way of a switch. The writing surface has a phosphorescent dispersion thereon. The phosphorescent dispersion has an excitation energy that is less than emission wavelength of the light source.

A magnet is optionally located proximal to the light source within a penlight stylus. A ferrite particulate decorated with phosphorescent dispersion stored in a reservoir beneath a writing surface is drawn onto the writing surface through a mesh separating the particulate reservoir from the writing surface by the magnet where the light source of the stylus stimulates the phosphorescent dispersion decorating the ferrite particulate.

### BRIEF DESCRIPTION OF THE DRAWINGS

FIG. 1 is a perspective partial cutaway view of a writing system according to the present invention;

FIG. 2 is a perspective view of another embodiment of the inventive writing system using phosphor coated magnetic particles within the writing tablet;

FIG. 3 is still another embodiment of the inventive writing system having a permanent magnet integrated into the stylus; and

FIG. 4 is still another embodiment of the inventive writing system having a security ink applied to an edge illuminated transparent sheet material.

### DETAILED DESCRIPTION OF THE PREFERRED EMBODIMENTS

The present invention has utility as a tablet that is writeable and readable under low ambient light conditions. Through the use of a penlight stylus impinging upon a tablet containing a phosphorescent material having an excitation energy that is less than the stylus photon energy, the phosphor is selectively excited only where exposed to stylus light. This spatially resolved phosphorescence induces a phosphorescent glow that is discernable under low ambient light conditions. As used herein, the term “low ambient light” is defined to mean an illumination of less than one Candle.

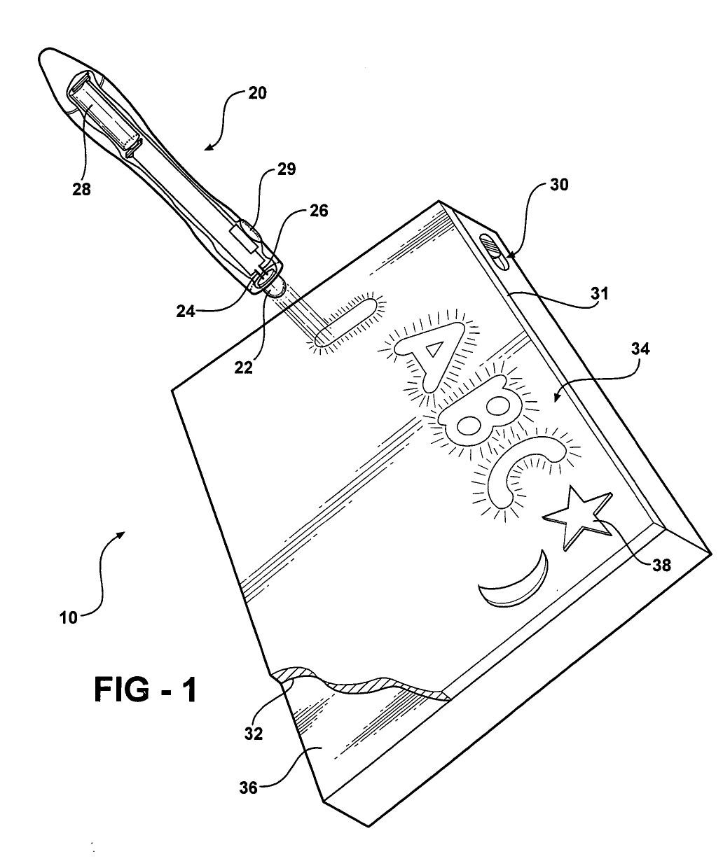

Referring now to FIG. 1, a writing system according to the present invention is shown generally at 10. The writing system 10 includes a penlight stylus 20 containing a light source powered by a battery therein. Preferably, the inventive light source is a light emitting diode, although it is appreciated that an incandescent or fluorescent bulb, such as a black light or cold cathode ray tube, is also operative herein. It is appreciated that the light source emission wavelength need only be greater than the excitation energy of a phosphor being impinged upon. A light source having visible or ultraviolet emission wavelengths is operative herein. Preferably, the light source emission wavelength is between 300 and 700 nanometers. More preferably, the emission wavelength is between 340 and 500 nanometers. Still more preferably, the light source emission wavelength is between 340 and 430 nanometers. The light source 22 has leads 24 and 26 extending therefrom that upon contact with opposite poles of a battery 28 is energized. A pressure switch 29 within the stylus 20 selectively contacts light source leads 24 and 26 into contact with the battery 28 with finger pressure and upon release springs back to an inactive position. The switch 30 is optionally equipped with a lock mechanism to maintain the light source 22 in an active condition. Alternatively, the light source 22 is mounted in a spring-loaded housing (not shown) so that the pressure of the light source against a surface serves to energize the light source 22. A spring loaded housing serves a safety function preventing emission from the stylus 20 being inadvertently directed into the eye of an onlooker. The writing surface 30 of inventive writing system 10 includes a dispersion 32 of phosphorescent inorganic particles or organic phosphorescent molecules. Inorganic phosphorescent particulate operative herein illustratively includes sulfides, selenides, oxides, phosphates and sulfates of alkaline earths, zinc, main group metals, and lanthanide doped forms thereof as exemplified in U.S. Pat. Nos. 2,372,071; 2,979,467; 4,725,324; 4,725,344; 4,857,228; and 6,005,024. A typical inorganic phosphorescent particle used herein has a domain size of between 0.3 and 100 microns. Organic luminescent molecules illustratively include coumarin, azo, cyanine, and quinoline dyes. The phosphorescent dispersion is preferably applied with a polymeric binder or adhesive to a substrate 34. More preferably, the surface 36 to which phosphorescent dispersion 32 is applied is polished to a reflective surface. A reflective substrate surface 36 serves to reflect stylus light penetrating the phosphorescent dispersion 32 back therethrough providing a second opportunity for the excitation thereof. Phosphorescent dispersion 32 forms a writing surface 30 by methods illustratively including applying a topcoat of phosphorescent material to a substrate, molding a polymeric sheet having phosphorescent material embedded therein, decorating a ferrite magnetic particle periphery with phosphorescent particulate and enclosing the decorated ferrite within a reservoir, and laminating phosphorescent material within layers that are at least partially transparent to stylus emissions. The ferrite particulate is preferably an order of magnitude or greater in domain size relative to the phosphorescent dispersion. It is appreciated that a phosphorescent decorative decal 38 is optionally applied to a writing panel 30. The decal 38 preferably has a different color of phosphorescence than the surface 30.

Erasure occurs by bleaching the entire writing surface with the penlight light wavelength. Alternatively, the writing surface is exposed to ambient light when the stylus wavelength is visible light. An ultraviolet light source wavelength is not immediately bleached by ambient room or sunlight.

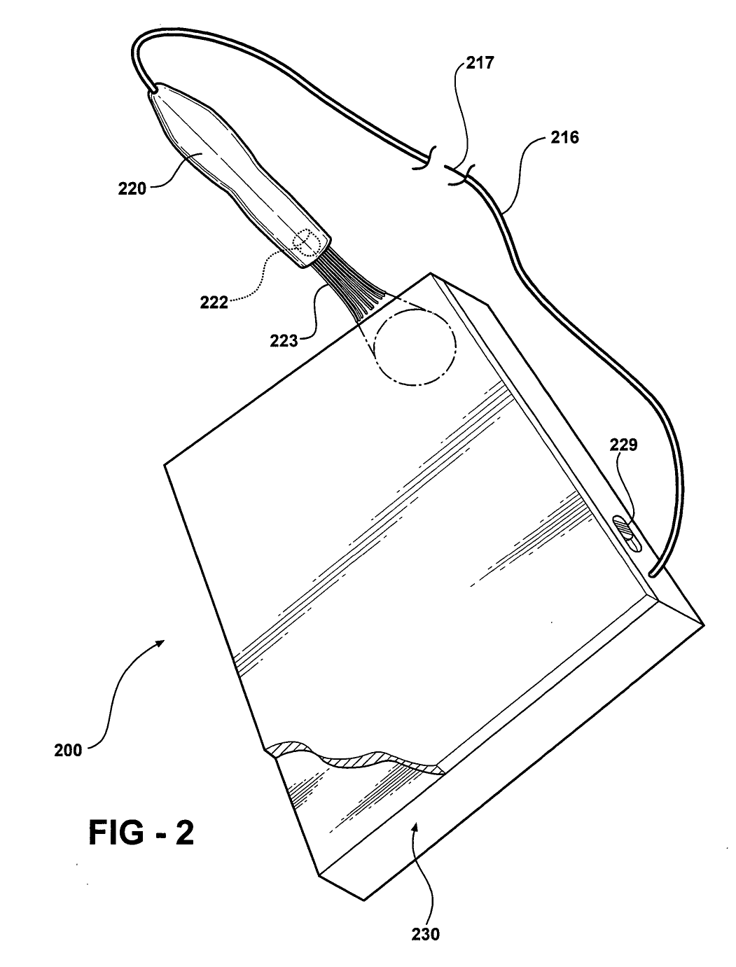

Another embodiment of an inventive writing system is shown generally at 200 in FIG. 2. To maintain a stylus 220 in proximity to a writing surface 230, a tether 216 is provided therebetween. It is appreciated that the dimensions of the stylus 220 are considerably reduced by providing a battery (not shown) and switch 229 to power light source 220 within the writing surface 230 with charge conducted between the battery and the stylus light source 222 by way of a conductive wire 217 within the tether 216. The stylus 220 optimally includes an optical fiber brush head 223 in order to provide a wider swath of light emission from the coupled light source 222 in order to obtain a wider written line width on the writing surface 230.

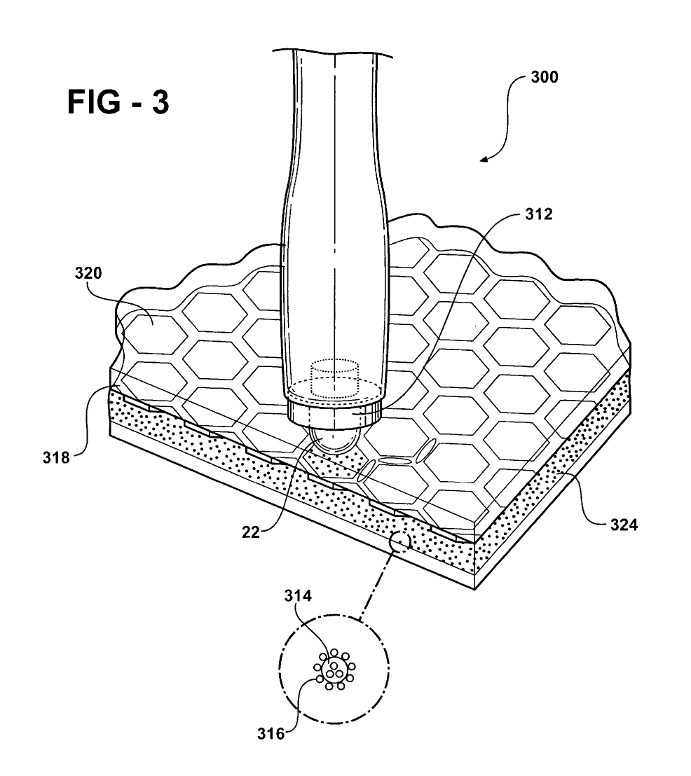

Still another alternate embodiment of an inventive writing system is shown at 300 in FIG. 3. An inventive light stylus as detailed with respect to FIG. 1 further includes a permanent magnet 312 proximal to the light source 22. The magnet serves to draw ferrite particulate 314 decorated with phosphor 316 through a mesh 318 and into the optical path of the emissions from the light source 22. The writing system according to FIG. 3 affords magnetic particulate 314 pulled onto the screen 320 that is visible above low ambient light conditions and phosphorescent decorating material 316 stimulated by the light source 22 to provide simultaneously low ambient light condition visible marking.

Erasure of an image according to this embodiment occurs by allowing the ferrite particulate 314 to drop beneath the supporting mesh 318 and into a particulate reservoir 324 or alternatively to be pulled into the reservoir 324 with a magnetic wand (not shown) sliding between the mesh 318 and reservoir 324.

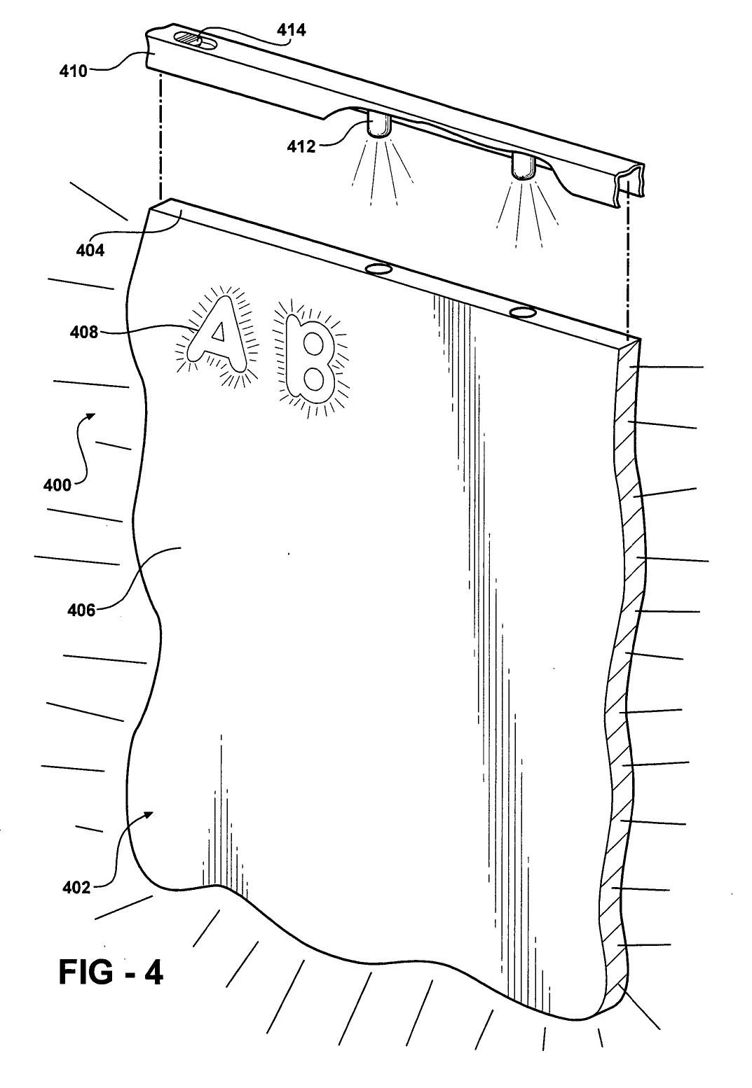

Still another embodiment of an inventive writing system is shown at 400 in FIG. 4. The writing system shown generally at 400 has an optically transparent sheet material 402 having an edge 404 and a writing surface 406. A conventional security marking instrument (not shown) having a fluorescent ink that is invisible under ambient light yet fluoresces under ultraviolet or black light. The security marker pen designated SAN/2100 manufactured by Sanford is representative of a security marking pen operative herein. Markings placed on the writing surface 406 of optically transparent sheet material 402 are latent without the security ink being exposed to light having a wavelength sufficient to induce fluorescence therein. The optically transparent sheet material 402 has an edge guard 410 including at least one ultraviolet light emitting diode 412 positioned to emit light into the edge 404 of the optically transparent sheet material 402. Internal reflection within the sheet material 402 retains the vast majority of emitted photons within the sheet material to be emitted from the edges 404. It is appreciated that a mercury arc lamp, black light lamp bulb, or cold cathode ray tube are also operative herein in place of the preferred UV LED 412. A switch 414 is incorporated into the edge guard 410 to selectively activate the UV LED 412. A power source for an ultraviolet LED, mercury arc lamp, black light lamp, or cold cathode ray tube is appreciated to be line power or batteries located within the edge guard 410. In the case of a UV LED, an internal battery supply within the edge guard 410 is preferred. The wavelength characteristics of a UV LED 412 or other light source are selected such that emission therefrom has a wavelength sufficient to stimulate the security ink 408 to fluoresce. The inventive writing system 400 represents a customizable, mobile, and high efficiency alternative to a conventional neon sign. During daylight hours, the sheet material appears as a conventional transparent viewing window while under low ambient light conditions with the activation of the stimulating light source, a brilliantly fluorescent security ink marking becomes visible. Optionally, a switch incorporated into the inventive writing system 400 includes a piezoelectric light sensor to automatically activate upon ambient light conditions dropping below a predetermined threshold.

Optical transparent sheet materials operative herein illustratively include acrylics, silicate glass, and quartz glass.

All publications and patents detailed herein are indicative of the level of skill in the art. Each publication or patent is incorporated herein by reference to the same extent as if each individual reference was explicitly and individually incorporated herein by reference.

The foregoing description is illustrative of particular embodiments of the invention, but is not meant to be a limitation upon the practice thereof. The following claims, including all equivalents thereof, are intended to define the scope of the invention.

1. A writing system comprising in combination:
a penlight stylus having a light source selected from the group consisting of: a light emitting diode, a black light and a cold cathode ray tube, the light source having an emission wavelength;
a switch contacting a battery to selectively activate the light source; and
a writing surface having a phosphorescent dispersion thereon, the phosphorescent dispersion having an excitation energy less than emission wavelength of the light source.

2. The writing system of claim 1 wherein the light source is a light emitting diode.

3. The writing system of claim 1 wherein the emission wavelength is between 340 and 500 nanometers.

4. The writing system of claim 1 wherein the emission wavelength is between 340 and 430 nanometers.

5. The writing system of claim 1 wherein said switch is a pressure switch.

6. The writing system of claim 5 further comprising a lock mechanism for said pressure switch.

7. The writing system of claim 1 wherein said switch is located within said stylus.

8. The writing system of claim 1 wherein said switch is located within said writing surface.

9. The writing system of claim 7 wherein said battery is located within said stylus.

10. The writing system of claim 8 wherein said battery is located within said writing surface.

11. The writing system of claim 1 wherein said writing surface has a reflective polish.

12. The writing system of claim 1 wherein said phosphorescent dispersion is inorganic phosphorescent particulate.

13. The writing system of claim 1 wherein said phosphorescent dispersion is organic luminescent molecules.

14. The writing system of claim 12 wherein said inorganic phosphorescent particulate decorates a ferrite particulate.

15. The writing system of claim 14 further comprising a reservoir in communication with said writing surface by way of a mesh, said reservoir retaining ferrite particulate therein.

16. The writing system of claim 15 wherein said stylus further comprises a magnet proximal to said light source.

17. The writing system of claim 1 further comprising a tether affixing said stylus to said writing surface.

18. A writing system comprising a penlight stylus having:
a light emitting diode light source having an emission wavelength of between 340 and 500 nanometers;
a writing surface having a phosphorescent dispersion thereon, the phosphorescent dispersion having an excitation energy less than emission wavelength of the light emitting diode light source.

19. The writing system of claim 18 wherein said phosphorescent dispersion is inorganic phosphorescent particulate.

20. The writing system of claim 19 wherein said inorganic phosphorescent particulate has an average domain size of between 0.3 and 100 microns.

21. The writing system of claim 18 wherein said phosphorescent dispersion is an organic fluorescent molecule.

22. The writing system of claim 19 wherein said inorganic phosphorescent particulate decorates a ferrite particulate.

23. The writing system of claim 22 further comprising a reservoir in communication with said writing surface by way of a mesh, said reservoir retaining ferrite particulate therein.

24. The writing system of claim 23 wherein said stylus further comprises a magnet proximal to said light source.

25. The writing system of claim 18 further comprising a tether affixing said stylus to said writing surface.

26. A writing system comprising:
an optically transparent sheet material having a writing surface and an edge;
a security ink marking on the writing surface, said marking being visible upon exposure to an ultraviolet wavelength; and
a light source emitting a wavelength into the material edge, the wavelength being shorter than or equal to the ultraviolet wavelength.

27. The writing system of claim 26 further comprising an edge guard housing said light source.

28. The writing system of claim 26 wherein said light source is a light emitting diode.

29. The writing system of claim 26 wherein the wavelength is between 340 and 430 nanometers.

30. The writing system of claim 26 further comprising a switch to selectively activate said light source.

31. The writing system of claim 30 further comprising an ambient light sensor activating said switch upon ambient light decreasing below a preselected threshold.

32. The writing system of claim 27 further comprising a battery or series circuit of batteries having sufficient voltage to power said light source within said edge guard.

33. The writing system of claim 26 wherein said sheet material is selected from a group consisting of: acrylic, silicate glass, and quartz glass.

34. A writing process comprising the steps of:
bringing a penlight stylus having a light source proximal to a magnet into proximity with a screen having a particulate reservoir thereunder, the particulate reservoir containing ferrite particulate decorated with phosphor, said reservoir and said screen in particulate communication by way of a mesh;
allowing sufficient time for said magnet to draw said phosphor decorated ferrite particulate through said mesh onto said screen;
activating said light source; and
stimulating emission from said phosphor decorated ferrite particulate with an output from said light source.

35. The process of claim 34 wherein the steps of bringing said stylus into proximity with said writing surface and activating said light source occur simultaneously.

36. The process of claim 34 further comprising the step of returning said phosphor decorated ferrite particulate into said reservoir.
